(19) United States
(12) Patent Application Publication
(10) Pub. No.: US 2019/0347660 A1
(43) Pub. Date: Nov. 14, 2019

(54) SYSTEM AND METHOD FOR PROTECTION OF CONFIDENTIAL INFORMATION

(71) Applicant: Walmart Apollo, LLC, Bentonville, AR (US)

(72) Inventors: Bruce WILKINSON, Rogers, AR (US); Joseph JURICH, Molino, FL (US)

(73) Assignee: Walmart Apollo, LLC, Bentonville, AR (US)

(21) Appl. No.: 16/404,905

(22) Filed: May 7, 2019

Related U.S. Application Data
(60) Provisional application No. 62/669,066, filed on May 9, 2018.

(51) Int. Cl. G06Q 20/40; G06F 16/23

(52) U.S. Cl. CPC G06Q 20/401; G06Q 2220/00; G06F 16/2308

(57) ABSTRACT

A blockchain-based method for sharing confidential information includes: receiving the confidential information shared by a plurality of parties; receiving an agreement regarding the confidential information; receiving a financial bond from each party who is responsible for the agreement for a period time of the agreement; storing the confidential information, the agreement, and the financial bond in corresponding blocks of a blockchain; receiving behavior data of a party wherein the behavior data is associated with the confidential data and the agreement; and analyzing the behavior data against the confidential data and the agreement to determine whether the party violates the agreement.

### CROSS REFERENCE TO RELATED APPLICATION

This patent application claims the benefit of U.S. Provisional Application No. 62/669,066, filed on May 9, 2018, content of which is incorporated by reference herein.

### BACKGROUND

### 1. Technical Field

The present disclosure relates to information technology, and more specifically to a system and method for protection of confidential information.

### 2. Introduction

Blockchain is a shared and distributed ledger that may facilitate the process of recording transactions and tracking assets in a peer-to-peer network. An asset may be tangible (e.g., a house, a car, and so on). An asset may also be intangible like intellectual property (IP), such as patents, copyrights, or branding. For example, a blockchain-based IP system may facilitate sharing confidential information by two or more parties and reduce disputes among the parties.

When the two or more parties enter an agreement, a party may want to ensure that their confidential information is not disclosed or become generally available. There is a need for systems and methods of securely sharing confidential information, and then resolving issues regarding unauthorized disclosure of the shared confidential information.

### SUMMARY

A method for performing concepts disclosed herein can include: receiving, by a computer, confidential information shared among a plurality of parties; receiving and storing, by the computer, an agreement regarding the confidential information; receiving, by the computer, a financial bond from each party who is responsible for the agreement for a period time of the agreement; storing, by the computer, the confidential information, the agreement, and the financial bond in corresponding blocks of a blockchain; receiving, by the computer, behavior data of a party wherein the behavior data is associated with the confidential information and the agreement; and analyzing and comparing, by the computer, the behavior data against the confidential information and the agreement to determine whether the party violates the agreement.

A system configured as disclosed herein can include: a processor; and a computer-readable storage medium having instructions stored which, when executed by the processor, cause the processor to perform operations comprising: receiving confidential information shared among a plurality of parties; receiving and storing an agreement regarding the confidential information; receiving a financial bond from each party who is responsible for the agreement for a period time of the agreement; storing the confidential information, the agreement, and the financial bond in corresponding blocks of a blockchain; receiving behavior data of a party wherein the behavior data is associated with the confidential information and the agreement; and analyzing and comparing the behavior data against the confidential information and the agreement to determine whether the party violates the agreement.

A non-transitory computer-readable storage medium configured as disclosed herein can have instructions stored which, when executed by a computing device, cause the computing device to perform operations which include: receiving confidential information shared among a plurality of parties; receiving and storing an agreement regarding the confidential information; receiving a financial bond from each party who is responsible for the agreement for a period time of the agreement; storing the confidential information, the agreement, and the financial bond in corresponding blocks of a blockchain; receiving behavior data of a party wherein the behavior data is associated with the confidential information and the agreement; and analyzing and comparing the behavior data against the confidential information and the agreement to determine whether the party violates the agreement.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an exemplary mesh network between a plurality of parties for sharing confidential information;

FIG. 2 illustrates an exemplary blockchain based on interactions between the plurality of parties;

FIG. 3 illustrates a block diagram of a blockchain-based process for sharing confidential information;

FIG. 4 illustrate an exemplary method of sharing confidential information by the plurality of parties based on blockchain; and

FIG. 5 illustrates an exemplary computer system.

### DETAILED DESCRIPTION

Systems, methods, and computer-readable storage media configured according to this disclosure are capable of protecting, analyzing, and evaluating disclosure of confidential information. The systems, methods, and computer-readable storage media described herein may also be applicable to any technology subject to a non-disclosure agreement (NDA). By using a blockchain, access to information can be decentralized. In addition, the authenticity and “chain of title” of the information can be irrefutable. The blockchain is also tamper-evident. A transaction cannot be tampered with after it been recorded to the blockchain. If a transaction is changed, a new transaction must be used to reverse the change, and both transactions are then visible. A single and shared blockchain can provide a mechanism to determine improper disclosure of confidential information.

By using blockchain to protect confidential information under NDA or other agreement, the chain of transactions is complete from start to finish. The proof of the movement and disclosure of the confidential information is irrefutable.

In some embodiments, a blockchain system with a smart contract (e.g., an Ethereum contract system) may be used to maintain and administer the smart contract and requisite information. The requisite information may include: confidential data (the purpose of the NDA) shared by any party, confidential data access rules, a period of performance of the smart contract, performance metrics and payment information (if the NDA is associated with a separate contract), court authority or arbitration authority, and performance bond agency(s).

In some embodiments, the NDA may include provisions defining remedies for a breach of the NDA. For example, in the case of a breach of the NDA (e.g., disclosure of confidential information), a provision may require a bond from each party to be held in the smart contract system for the period of the NDA. Each party receiving confidential information may be responsible for posting a bond into the smart contract system. The past behavior of each party may be used to determine the risk of NDA violation and hence, the bond cost.

In some embodiments, the disclosed system may also include a court or arbitration determination provision of the smart contract. Such a provision may be required to determine if there has been a NDA violation. If the court or arbitrator determines that a NDA violation occurred, the court or arbitrator may provide the private key of the party who violates the NDA. The private key may be used to release the bond of the violating party. The released bond may be used to compensate the party whose confidential information was disclosed.

In some embodiments, the disclosed system and method may automatically determine whether there has been compliance with the NDA or other agreement by the parties. The disclosed system may automate everything so that no arbitrator or the like is required. For example, the penalty (e.g., a digital currency) can be automatically allocated when a breach of the NDA or a disclosure of the confidential information is detected.

Parties to a NDA may place their background data (e.g., electronic data, all publications, or any kind of things that the party has that can be scanned and analyzed) in the smart contract system. This background data may include confidential data that is protected by the NDA. The background data can be compared and analyzed against later disclosed information (e.g., marketing information, any kind of public disclosure, patent filings, etc.) to determine if confidential information subject to the NDA has been disclosed. To detect a potential breach of the NDA, Internet scraping, searching, and the like, may be automatically performed. For example, public patent applications of the parties to the NDA may be searched and compared against the confidential information stored in the blockchain under the smart contract. These disclosures of the party may be compared with the confidential information to identify potential breaches of the NDA.

In some embodiments, a machine learning scheme may be used to analyze the available public information disclosed by a party to the NDA against the confidential information stored in the blockchain under the smart contract to determine a disclosure of the confidential information and a breach of the NDA. The machine learning scheme may include a clustering algorithm, named entity algorithm, multiclass classification, etc. For example, the machine learning scheme may use natural language processing to compare the confidential information with the disclosed information. The natural language processing may include speech recognition, natural language understanding, and natural language generation. The natural language processing may further include morphological segmentation, part-of-speech tagging, parsing, sentence breaking, work segmentation, terminology extraction, machine translation, relationship extraction, sentiment analysis, topic segmentation, word sense disambiguation, automatic summarization, coreference resolution, disclosure analysis, and so on.

In a case where the NDA involves patent filing, once patents or patent publications become public, the disclosed system can continue scanning all public records of parties to the NDA. The disclosed system may continue the process of mapping the patent application affinities against the confidential information to determine whether there is a breach of the NDA. This process may last, for example, 5 years, 10 years or any time period specified in the smart contract. If a party does not properly disclose that the patent applications are pertinent to the NDA, then there may have a monetary payout for such breach of the NDA. The available public information may include, but limited to, patent applications, provisional application applications, copyright documents, trademark documents, and other confidential or undisclosed IP-related documents.

In some embodiments, a peer-to-peer network may be used to implement the disclosed system. If a peer-to-peer network is permissioned, it can enable the creation of a parties-only network with proof that the parties are who they say they are and that the documents are exactly as represented. This may protect the disclosed system against tampering, fraud, or cybercrime.

In some embodiments, through the use of identifications (IDs) and permissions, parties can specify which details of their confidential information they want other parties to view. Permissions can be expanded for special circumstances. For example, to resolve ownership issues for a jointly developed technology, a court or arbitrator may be authorized to aaccess all confidential information of all the parties specified in the NDA.

In some embodiments, permissions and cryptography may be used to prevent unauthorized access to the peer-to-peer network and ensure that parties are who they claim to be. Privacy can be maintained through cryptographic techniques or data partitioning techniques to give parties selective visibility into the blockchain. Both the confidential information and the identities of parties who own the confidential information can be masked. After conditions are agreed to, parties cannot tamper with a record of the NDA.

In some configurations, communications between the parties can take the form of a blockchain, where each request and response made by the parties can be added to the blockchain. As any party takes an action (e.g., sending a request, sending a response to the request), that information of the action is added to the blockchain. More specifically, the request, response, or other action is hashed into the previous blockchain. This new, updated blockchain is then distributed to the other parties within the group.

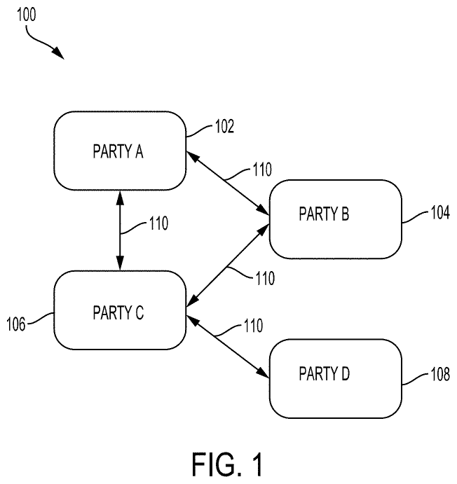

Various specific embodiments of the present disclosure are described in detail below. While specific implementations are described, it should be understood that this is done for illustration purposes only. Other components and configurations may be used without parting from the spirit and scope of the present disclosure, and can be implemented in combinations of the variations provided. These variations shall be described herein as the various embodiments are set forth. The present disclosure now turns to FIG. 1.

FIG. 1 illustrates an exemplary peer-to-peer network 100 between a plurality of parties 102, 104, 106, 108 who may share confidential information. A peer-to-peer network such as that illustrated is a network where each node can relay data from and to other nodes within the network. While peer-to-peer networks can be constructed to operate in wired conditions, they are more prevalent in wireless configurations, where messages can be broadcast to other nearby nodes (i.e., not sent to a specific node, but rather all nodes within a given distance of the broadcasting node). When a receiving node is located outside the broadcast range of a transmitting node, intermediate nodes may be required to route the transmission to the receiving node. For example, as illustrated, node 102 (party A) can communicate 110 with nodes 104 (party B) and 106 (party C), and nodes 104 and 06 can communicate 110 with each other. However, nodes 102 and 104 cannot communicate with node 108 (party D). Because node 108 can only communicate with node 106, any communications 110 between node 102 and node 108, or between node 104 and node 108, must route through node 106.

When sharing confidential information, the parties may communicate with one another via the peer-to-peer network 100. That is, the parties may use devices at each node to transmit, receive, and relay messages between themselves as necessary. The devices used by the parties may include, but not limited to, mobile phones, computing tablets, desktop computers, servers, laptop computers, smart phones, mainframes, and so forth.

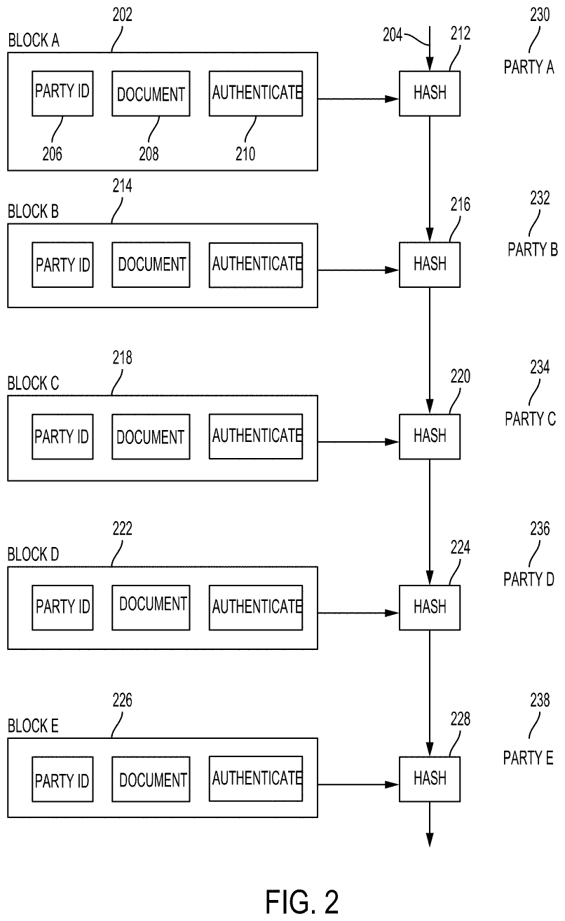

FIG. 2 illustrates an exemplary blockchain based on interactions between parties involving sharing confidential information using the network 100 of FIG. 1. Each transaction recorded within the blockchain may be a block which can be hashed or otherwise encrypted. As new transactions are added to the blockchain, each new transaction's veracity can be tested against the previous blockchain stored by the devices. Each new transaction can, in some configurations, require confirmation from a defined percentage (usually 50%) of the devices to be added to the blockchain.

In the case of protecting and sharing confidential information, the blockchain can take the form illustrated in FIG. 2. In this example, there is a blockchain 204 which is distributed among the parties. One of the parties (e.g., party A 230) may store their confidential information in a block of the blockchain 204. In this example, a block (Block A 202) is generated to store the confidential information and related data of party A 230. The block 202 added to the blockchain 204 may contains an ID 206 of party A 230, or an address or identification of a device that may be used by the party A 230, and the documents 208.

In addition, block 202 can contain an authentication portion 210. The authentication portion 210 may set restrictions of different levels on the documents 208 and the party ID 206. For example, the documents 208 or the party ID 206 may be set not to be visible or accessible to other parties other than party A. The authentication portion 210 may authorize other parties to view partial portion or details of the documents 208 and the party ID, for example, the title of a document. In addition, the authentication portion 210 may authorize a full access to the documents 208 to other parties who sign the NDA as well as to an arbitrator (e.g., a machine learning scheme or an analytic engine to compare and analyze the documents 208 and other public information to determine if the NDA is breached). The documents 208 may be encrypted.

The documents 208 may also be part of a smart contract, which is an agreement or set of rules that govern the NDA and the confidential information. For example, the smart contract may define contractual conditions under which the confidential information is accessed and evaluated, how disputes are resolved, and measures and penalties for breaching the NDA. The smart contract is stored on the blockchain and is executed automatically as part of a transaction.

As the device generates the block 202, the block 202 is hashed 212 into the previous blockchain 204, resulting in an updated blockchain which is distributed among the parties in the group.

The other parties receive the updated blockchain containing the block 202. Another party, for example, party B 232 may store their confidential information under the NDA. In this case, party B 232 may generate a block 214 to store their confidential information in the blockchain 204. Similar to block 202, the block 214 may store the confidential information and related data of party B 232, an ID of party B 232, or an address or identification of a device that may be used by the party B 232, and an authentication portion.

In some embodiments, the party B 232 may not provide their own confidential information and just access the confidential information of party A 230. In this case, party B 232 may just sign the NDA and the smart contract, and then store those signed documents to a document portion of block 214.

As the device generates the block 214, the block 214 is hashed 216 into the previous blockchain 204, resulting in an updated blockchain which is distributed among the parties in the group

Similarly, party C 234 may also want to join the NDA. Block 218 may be generated accordingly and hashed 220 into the blockchain 204, resulting in an updated blockchain which is then distributed among the parties in the group.

Parties A, B, and C, each may place a financial bond in their corresponding blocks of the blockchain 204. Those bonds may be used as a payment or compensation for breaching the NDA. Those bonds may also be saved in an escrow account owned by a third party, such as a bonding agency party D 236. The bonding agency 236 may provide or administer the bond on behalf of one or more parties. The bonds may be in a form of digital currency. The bonds and associated information may be stored in a block 222 and hashed 224 into the blockchain 204.

Party E 238 may be an arbitrator module to automatically monitor and analyze the confidential information, the bonds, the NDA, the smart contract, and the public available information to determine whether there is a breach of the NDA. If a breach of the NDA is determined, the arbitrator module identifies who breached the NDA (an offending party) and whose confidential information is breached (an offended party). The bond of the offending party can be automatically unlocked and transferred to the offended party. The arbitrator module may generate a block 226 which is hashed 228 into the blockchain 204. The block 226 may include comparison, analysis results, and bond unlocking and transfer information in the document portion.

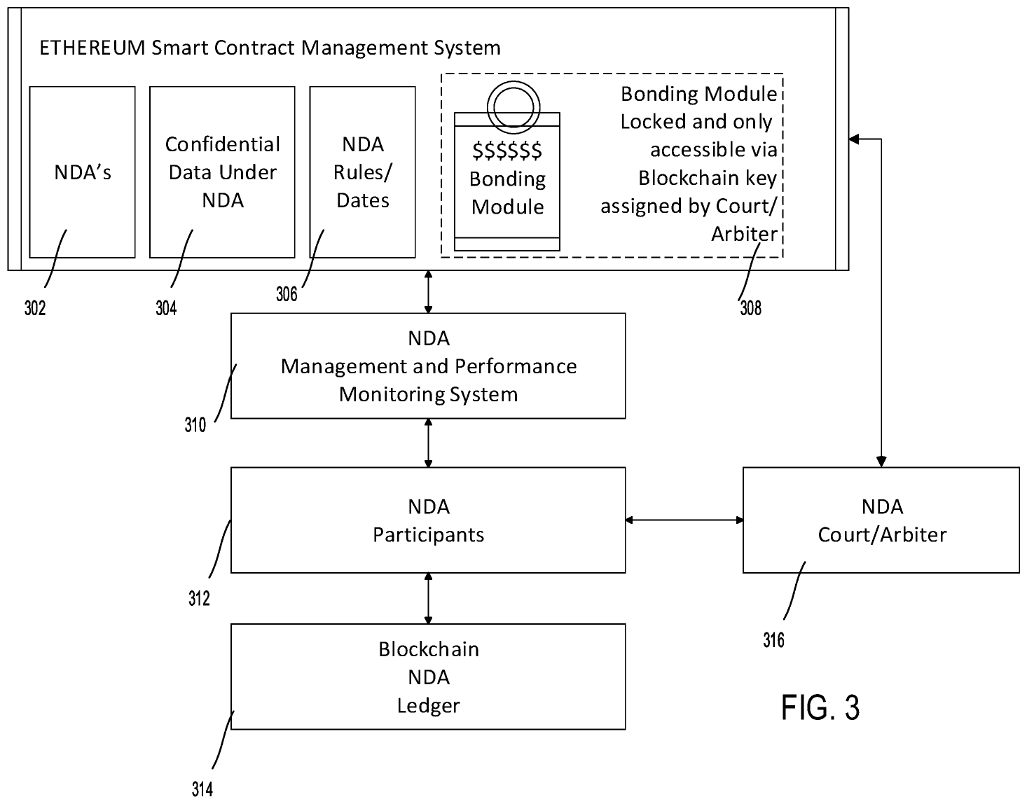

FIG. 3 illustrates a block diagram of a blockchain-based process for protecting and sharing confidential information. In this example, a blockchain platform Ethereum system may be used to store and secure the confidential information, NDA and associated rules, and bonds from each participating party. A NDA management and performance monitoring system, such as a machine learning scheme, as described above, may be employed to keep track of whether the NDA is breached.

One or more NDAs 302 may be stored. The terms or rules of the NDA may be defined as part of a smart contract that is run and implemented on the Ethereum system. Confidential data 304 covered by the NDA 302 may be stored. The confidential data 304 may be unpublished patent applications, trade secrets, and any other confidential information owned by NDA participants 312. NDA rules or dates 306 may be stored. The NDA rules may define how to access the confidential data and the NDA. The NDA may also define dates on which the confidential information may be stored or when searches for disclosures of the confidential information are periodically done. Block 308 may store a bonding module in which bond information for each of the NDA participants 312 may be stored. The bond may be used for compensation due to breach of the NDA. The bonding module may be locked and only be accessible via blockchain private keys assigned by NDA court/arbitrator 316 or by a NDA management and performance monitoring system 310.

The NDA management and performance monitoring system 310 may be used to track the performance of the NDA and to determine if the NDA is breached. For example, the confidential data 304, NDA 302, NDA rules or dates 306, and the available public information may be communicated from the Ethereum smart contract management system to the NDA management and performance monitoring system 310, and evaluated by the NDA management and performance monitoring system 310 to determine whether a disclosure of the confidential information occurred. Once a breach is determined by the system, it may optionally be confirmed by the NDA court/arbitrator 316. The private key of the breaching party may be used to retrieve the bond of the breaching party.

Analysis results and/or performance of NDA determined by the NDA management and performance monitoring system 310 may be stored in the blockchain NDA ledger 314. The available public information may also be stored in the blockchain NDA ledger 314.

In some embodiments, the confidential information may be encrypted. The party loading the confidential information into the blockchain has a private key. The party may provide its private key so that the NDA management and performance monitoring system 310 can have a full access to the confidential information to do the comparison and analysis.

The confidential information of a party may be analyzed to generate a hierarchical structure with regard to technical field or category of the contents of confidential information. For example, the confidential information may cover computer technology, further may be related to computer hardware, and even further may be related to central computing unit (CPU) manufacturing, and so on, such that a hierarchical structure of the confidential information can be created. That is, the hierarchical structure may comprise a plurality of technical area levels.

In some embodiments, to resolve the ownership of a joint IP, the disclosed system may map the confidential information to pre-existing documents. For example, the confidential information and the pre-existing documents may be compared and mapped to build or generate a hierarchical structure or confidence level to determine if the confidential information has been disclosed.

Once a hierarchical structure is generated, mapping and comparison between two hierarchical structures can be performed to determine an affinity between the disclosed information and the confidential information. For example, if there is a match of a technical area at a corresponding level of the hierarchical structure (e.g., 90% match), a high affinity (e.g., 1) may be assigned to this technical area. Similarly, a medium affinity (e.g., 0.5) may be assigned to a technical area at another level, and so forth. A final affinity between the two hierarchical structures may indicate a degree to which the confidential information is disclosed.

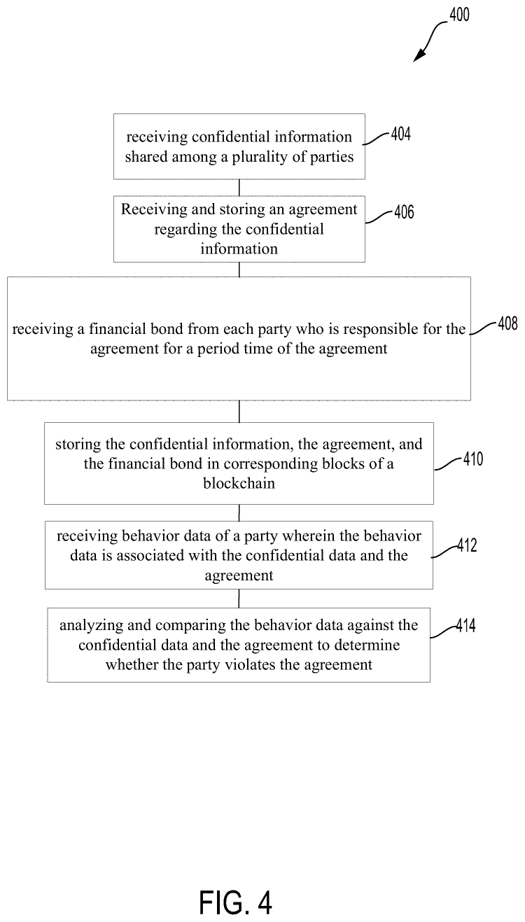

FIG. 4 illustrates an exemplary method 400 of protecting and sharing confidential information among a plurality of parties based on blockchain. The method 400 may be implemented in the above disclosed systems, and may include the following steps. Thus, some details are not repeated herein and may refer to the above description.

At step 404, the confidential information shared by a plurality of parties is received. As described above, the confidential information may be stored in corresponding blocks of a blockchain. Each party may be a party to an agreement (e.g., NDA) and shares or has access to the confidential information.

At step 406, the agreement regarding the confidential information is received and stored. The agreement may be a NDA or any other agreement. The agreement may include access rules to the confidential information, a period of performance of the agreement, performance metrics and payment information, court authority or arbitration authority, and a performance bond agency. An Ethereum smart contract management system may administer the agreement.

At step 408, a financial bond from each party who is responsible for the agreement for a period time of the agreement is received. As described above, the bond can be used as a payment or compensation for an offended party due to a breach of the agreement or disclosure of the confidential information.

At step 410, the confidential information, the agreement, and the financial bond are stored in corresponding blocks of a blockchain. Those documents may be secured and encrypted.

At step 412, behavior data of a party is received. The behavior data may be associated with the confidential information and the agreement. As defined herein, the behavior data may include published patents, public seminar information, journal publications, conference articles, Internet posts, public speeches and presentations, and so forth.

At step 414, the behavior data is analyzed and compared against the confidential information and the agreement to determine whether the party violates the agreement. The violation of the agreement may include disclosure of the confidential information.

The method 400 may further comprise unlocking the financial bond of a party when the party is determined to violate the agreement. The party who violates the agreement may be referred to as an offending party. The bond of the offending party may be automatically transferred to an offended party according to the NDA or the smart contract.

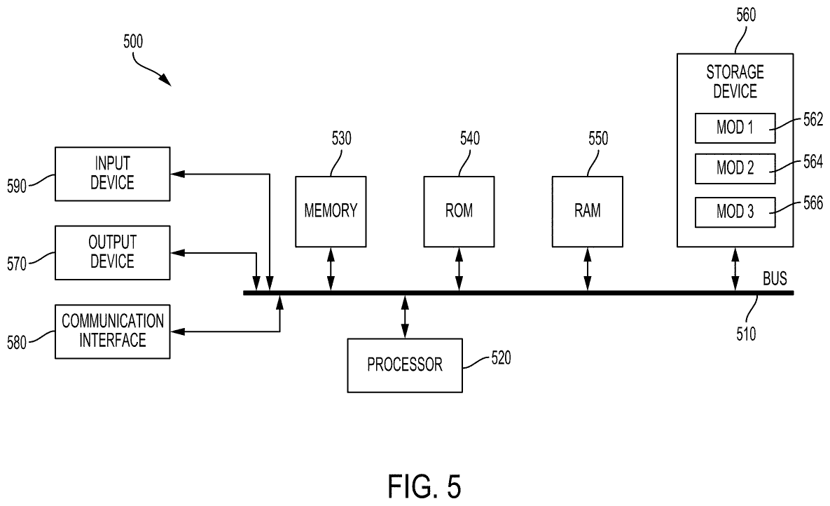

With reference to FIG. 5, an exemplary system 500 can include a processing unit (CPU or processor) 520 and a system bus 510 that couples various system components including the system memory 530 such as read only memory (ROM) 540 and random access memory (RAM) 550 to the processor 520. The system 500 can include a cache of high speed memory connected directly with, in close proximity to, or integrated as part of the processor 520. The system 500 copies data from the memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The memory 530 can include multiple different types of memory with different performance characteristics. It can be appreciated that the disclosure may operate on a computing system 500 with more than one processor 520 or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing system 500. In one aspect, a hardware module that performs a particular function includes the software component stored in a tangible computer-readable storage medium in connection with the necessary hardware components, such as the processor 520, bus 510, output device 570 as display, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the system 500 is a small, handheld computing device, a desktop computer, or a computer server.

Although the exemplary embodiment described herein employs the hard disk as the storage device 560, other types of computer-readable media which can store data that are accessible by a computer, such as magnetic cassettes, flash memory cards, digital versatile disks, cartridges, random access memories (RAMs) 550, and read only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing system 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing system 500. The communications interface 580 generally governs and manages the user input and system output. There is no restriction on operating on any particular hardware arrangement and therefore the basic features here may easily be substituted for improved hardware or firmware arrangements as they are developed.

The concepts disclosed herein can also be used to improve the computing systems which are performing, or enabling the performance, of the disclosed concepts. For example, information associated with confidential information, smart contract, jointly developed technology, etc., can be generated by local computing devices. In a standard computing system, the information will then be forwarded to a central computing system from the local computing devices. However, systems configured according to this disclosure can improve upon this “centralized” approach.

One way in which systems configured as disclosed herein can improve upon the centralized approach is combining the data from the respective local computing devices prior to communicating the information from the local computing devices to the central computing system. Rather than transmitting each individual piece of data each time new data is generated, such as the jointly developed technology, the various computing devices can cache the generated data for a period of time and combine the generated data with any additional data which is generated within the period of time. This withholding and combining of data can conserve bandwidth due to the reduced number of transmissions, can save power due to the reduced number of transmissions, and can increase accuracy due to holding/verifying the data for a period of time prior to transmission.

Another way in which systems configured as disclosed herein can improve upon the centralized approach is adapting a decentralized approach, where data is shared among all the individual nodes/computing devices of the network, and the individual computing devices perform calculations and determinations as required. Such a configuration may be more power and/or bandwidth intensive than a centralized approach, but can result in a more dynamic system because of the ability to modify assignments and requirements immediately upon making that determination. In addition, such a system can be more secure, because there are multiple points of failure (rather than a single point of failure in a centralized system).

It is worth noting that a “hybrid” system might be more suitable for some specific configurations. In this approach, a part of the network/system would be using the centralized approach (which can take advantage of the bandwidth savings described above), while the rest of the system is utilizing a de-centralized approach (which can take advantage of the flexibility/increased security described above).

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A blockchain-based method for sharing confidential information, comprising:
receiving, by a computer, the confidential information shared among a plurality of parties;
receiving and storing, by the computer, an agreement regarding the confidential information;
receiving, by the computer, a financial bond from each party who is responsible for the agreement for a period time;
storing, by the computer, the confidential information, the agreement, and the financial bond in corresponding blocks of a blockchain;
receiving, by the computer, behavior data of a party wherein the behavior data is associated with the confidential information and the agreement; and
analyzing and comparing, by the computer, the behavior data against the confidential information and the agreement to determine whether the party violates the agreement.

2. The method of claim 1, further comprising:
analyzing, by the computer, the confidential information to generate a hierarchy structure with regard to technical field or category of contents of the confidential information;
comparing and mapping, by the computer, the behavior data to the confidential information based on the hierarchical structure;
generating, by the computer, based on the comparison and mapping, an affinity level between the behavior data and the confidential information; and
determining, by the computer, based on the affinity level, a disclosure of the confidential information.

3. The method of claim 1, wherein the violation of the agreement includes leak of the confidential information.

4. The method of claim 1, wherein the agreement includes access rules of the confidential data, a period of performance of the agreement, performance metrics and payment information, court authority or arbitration authority, and a performance bond agency.

5. The method of claim 1, wherein the behavior data includes published patents.

6. The method of claim 1, wherein the each party is a party who signs the agreement and share the confidential information.

7. The method of claim 1, wherein the each party includes a bonding agency, and a court or arbitration party.

8. The method of claim 1, further comprising:
unlocking, by the computer, the financial bond of a party when the party is determined to violate the agreement.

9. A system, comprising:
a processor; and
a computer-readable storage medium having instructions stored which, when executed by the processor, cause the processor to perform operations comprising:
receiving, by the processor, confidential information shared among a plurality of parties;
receiving and storing, by the processor, an agreement regarding the confidential information;
receiving, by the processor, a financial bond from each party who is responsible for the agreement for a period time of the agreement;
storing, by the processor, the confidential information, the agreement, and the financial bond in corresponding blocks of a blockchain;
receiving, by the processor, behavior data of a party wherein the behavior data is associated with the confidential information and the agreement; and
analyzing and comparing, by the processor, the behavior data against the confidential information and the agreement to determine whether the party violates the agreement.

10. The system of claim 9, wherein the agreement is a non-disclosure agreement.

11. The system of claim 9, wherein the violation of the agreement includes leak of the confidential information.

12. The system of claim 9, wherein the agreement includes access rules of the confidential data, a period of performance of the agreement, performance metrics and payment information, court authority or arbitration authority, and a performance bond agency.

13. The system of claim 9, wherein the behavior data includes published patents.

14. The system of claim 9, wherein the each party is a party who signs the agreement and share the confidential information.

15. The system of claim 9, wherein the each party includes a bonding agency, and a court or arbitration party.

16. The system of claim 9, wherein the further instructions cause the processor to perform operations:
unlocking, by the processor, the financial bond of a party when the party is determined to violate the agreement.

17. A non-transitory computer-readable storage medium having instructions stored which, when executed by a computing device, cause the computing device to perform operations comprising:
receiving confidential information shared among a plurality of parties;
receiving and storing an agreement regarding the confidential information;
receiving a financial bond from each party who is responsible for the agreement for a period time of the agreement;
storing the confidential information, the agreement, and the financial bond in corresponding blocks of a blockchain;
receiving behavior data of a party wherein the behavior data is associated with the confidential information and the agreement; and
analyzing and comparing the behavior data against the confidential information and the agreement to determine whether the party violates the agreement.

18. The medium of claim 17, wherein the each party is a party who signs the agreement and share the confidential information.

19. The system of claim 17, wherein the different party includes the each party, a bonding agency, and a court or arbitration party.

20. The system of claim 17, wherein the further instructions cause the processor to perform operations:
unlocking the financial bond of a party when the party is determined to violate the agreement.
